(19) United States
(12) Patent Application Publication
(10) Pub. No.: US 2026/0219893 A1
(43) Pub. Date: Jul. 30, 2026

(54) Processor Environment Agnostic Firmware Management Operation Including a Graphics Processing Unit Offload Management Operation

(71) Applicant: Dell Products L.P., Round Rock, TX (US)

(72) Inventors: Shekar Babu Suryanarayana, Bangalore (IN); Karunakar Poosapalli, Telangana (IN); Niyathi Shenoy K, Kasaragod (IN)

(21) Appl. No.: 19/038,053

(22) Filed: Jan. 27, 2025

(51) Int. Cl. G06F 9/4401

(52) U.S. Cl. CPC G06F 9/4401

(57) ABSTRACT

A firmware management operation. The firmware management operation includes providing an information handling system with a distributed unified BIOS; identifying a processor environment installed on an information handling system from a plurality of processor environments, the processor environment comprising a processor architecture, the information handling system including a graphics processing unit (GPU); and, performing a GPU offload management operation, the GPU offload management operation managing an aspect of offloading a processing operation to the GPU.

### BACKGROUND OF THE INVENTION

### Field of the Invention

The present invention relates to information handling systems. More specifically, embodiments of the invention relate to performing a firmware management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed unified BIOS; identifying a processor environment installed on an information handling system from a plurality of processor environments, the processor environment comprising a processor architecture, the information handling system including a graphics processing unit (GPU); and, performing a GPU offload management operation, the GPU offload management operation managing an aspect of offloading a processing operation to the GPU.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed unified BIOS; identifying a processor environment installed on an information handling system from a plurality of processor environments, the processor environment comprising a processor architecture, the information handling system including a graphics processing unit (GPU); and, performing a GPU offload management operation, the GPU offload management operation managing an aspect of offloading a processing operation to the GPU.

In another embodiment the invention relates to a computer-readable storage medium embodying computer program code, the computer program code comprising computer executable instructions configured for: providing an information handling system with a distributed unified BIOS; identifying a processor environment installed on an information handling system from a plurality of processor environments, the processor environment comprising a processor architecture, the information handling system including a graphics processing unit (GPU); and, performing a GPU offload management operation, the GPU offload management operation managing an aspect of offloading a processing operation to the GPU.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 shows a simplified block diagram of multi-processor operating environment;

FIG. 3 shows a simplified block diagram of an architecture-specific distributed firmware management platform;

FIGS. 4a through 4c are a simplified block diagram showing the performance of certain distributed firmware management operations;

FIG. 5 is a simplified block diagram of Authenticated Basic Input/Output System (BIOS) Interface services implemented within a cloud computing environment;

FIGS. 6a and 6b are a simplified block diagram showing the performance of certain Central Processing Unit (CPU) offload management operations;

FIG. 7 is a simplified block diagram of the operation of a firmware virtual interpolation protocol; and

FIG. 8 is a simplified block diagram of a CPU offload learning model.

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the invention reflect an appreciation that optimizing power management of Universal Serial Bus (USB) Type-C ports is not only about adhering to stringent power delivery negotiations but also about innovative methods to distribute workloads efficiently. Likewise, various aspects of the invention reflect an appreciation that USB workload processing has traditionally been highly Central Processing Unit (CPU) centric, which often leads to increased power consumption and potential performance bottlenecks during intensive CPU states. Various aspects of the invention likewise reflect an appreciation that it may be advantageous to use a novel learning approach to understand the context of a USB workload and under certain circumstances, offload it from the CPU to a Graphics Processing Unit (GPU), Neural Processing Unit (NPU), or Accelerated Processing Unit (APU).

By doing so, power efficiency may be significantly enhanced, and device operations remain uninterrupted, even during CPU busy states. More specifically, the parallel processing capabilities a GPU, NPU, or APU, allow it to handle USB tasks more efficiently, thereby reducing power usage and ensuring USB function availability during an IHS's boot phase.

Various aspects of the invention reflect an appreciation that third party vendor firmware for USB-C systems is typically tightly coupled with silicon code from CPU vendors for enumeration in boot path and functional support. Due to this vendor code interdependency, USB enumerations for some device types may fail and USB power rail division may become inefficient for parallel workloads. Likewise, various aspects of the invention reflect an appreciation that such vendor code interdependency may result in USB audio/video (AV) offload playback experiencing intermittent glitches, resulting in an erratic AV experience during CPU busy states. Various aspects of the invention likewise reflect an appreciation that such issues are typically more related to USB devices that are offloading AV stream playback and typically do not occur with non-offload streams, even when the CPU is under heavy load.

Various aspects of the invention reflect an appreciation that unsynchronized Memory-Mapped Input/Output (MMIO) regions across BIOS and embedded controller (EC), as it relates to USB-C allocations and static video buffer (V-buffer), may result in audio distortion, glitches, system hang, and crashes during online streaming content playback. Likewise, various aspects of the invention reflect an appreciation that enabling secure biometrics and USB audio offload features in the BIOS of a Windows®-based system may result in issues with the eXtensible Host Controller Interface (XHCI) when entering the IHS's operating system (OS) and a device is missing, which may result in requiring multiple reboots to restore USB secure audio functions.

Various embodiments of the invention likewise reflect an appreciation that disabling USB AV offload may cause additional system power consumption (e.g., ~1200 mW) when AV playback is captured on a USB endpoint connected to the root port. Various aspects of the invention reflect an appreciation that audio offloading to an Audio Digital Signal Processor (ADSP) is known, but additional hardware is required for such approaches. Likewise, various aspects of the invention reflect an appreciation that no current approach exists to enable seamless CPU offload with power efficient and uninterrupted services.

For purposes of this disclosure, an information handling system (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

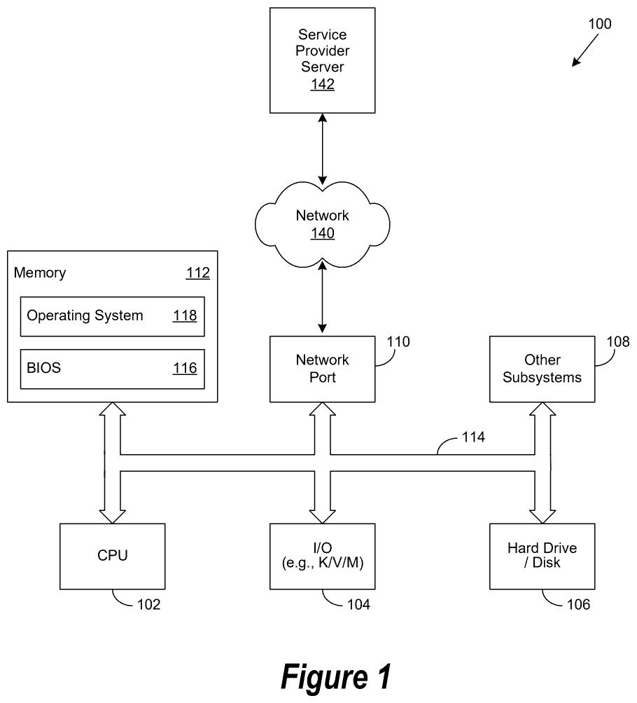

FIG. 1 is a generalized illustration of an information handling system that can be used to implement the system and method of the present invention. In certain embodiments, the information handling system (IHS) 100 may be implemented to include a processor (e.g., central processing unit or “CPU”) 102, various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), erasable programmable read-only memory (EPROM), electrically erasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS's 100 hardware. In various embodiments, the BIOS 116 may be implemented to initialize and test certain hardware components of its associated IHS 100 during the booting process (e.g., Power-On Self-Test, or “POST”), followed by loading a boot loader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS's 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS's 100 initialization and startup within an .efi file, rather than on its associated firmware. In typical implementations, the .efi file may be stored on a special memory partition known as an EFI System Partition (ESP), which also contains the IHS's 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein. In certain embodiments, the distributed BIOS 116 may be implemented as a distributed unified BIOS. As used herein, a distributed unified BIOS 116 broadly refers to a BIOS 116 that includes a plurality of BIOS 116 components, or a plurality of BIOS 116 variables, or a plurality of BIOS 116 storage locations, or a combination thereof, which are implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100. In various embodiments, the firmware management operation may be implemented to include the performance of a Central Processing Unit (CPU) offload management operation.

A CPU offload management (COM) operation, as used herein, broadly refers to any function, task, procedure, or process performed, directly or indirectly, within a multi-processor operating environment, or an architecture-specific distributed firmware management platform (ASDFMP), both of which are described in greater detail herein, to manage one or more aspects of offloading certain processing operations performed by a CPU 102 to an associated Graphics Processing Unit (GPU) Neural Processing Unit (NPU), or Accelerated Processing Unit (APU), or a combination thereof, to facilitate the provision of one or more Uniform Serial Bus Type C (USB-C) port functionalities. In certain embodiments, the firmware management operation may be performed during operation of an IHS 100. In various embodiments, performance of the firmware management operation may result in the realization of improved operation of an IHS 100.

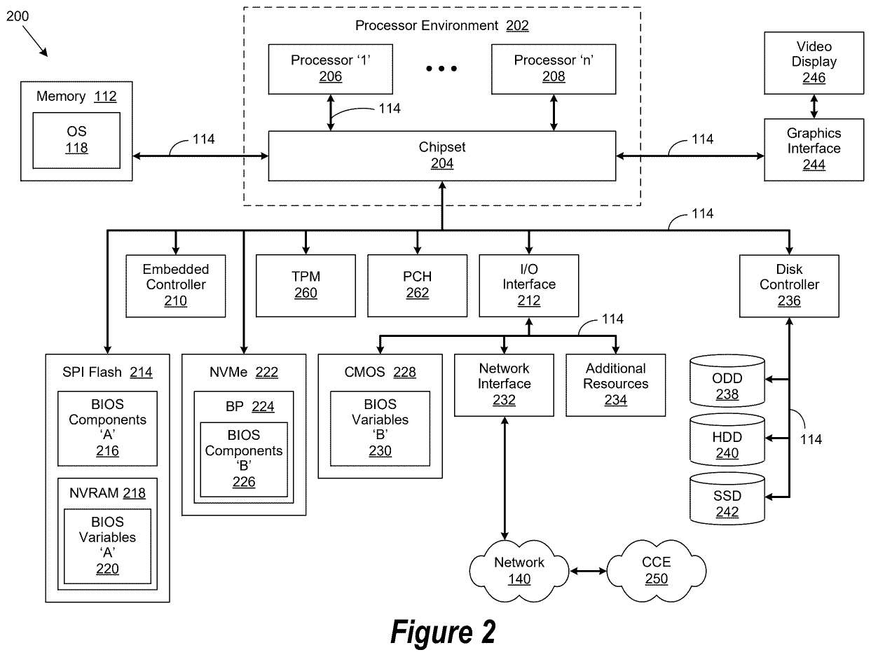

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as an information handling system (IHS), described in greater detail herein, such as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208. In various embodiments, the one or more architectures can include an x86 type processor architecture, an Advanced Reduced Instruction Set Computer (RISC) Machines (ARM) type processor architecture, or a combination thereof. In various embodiments, a processor environment implementing an x86 type processor architecture provides an x86 type processor environment. In various embodiments, a processor environment implementing an ARM type processor architecture provides an ARM type processor environment.

As an example, processors ‘1’ 206 through ‘n’ 208 of a particular PE 202 may be implemented to be the same in a server. In this example, each processor may be assigned to be a resource to one or more virtual machines (VMs). As another example, processor ‘1’ 206 may be implemented as a multi-core processor in a graphics work station, while processor ‘n’ 208 may be implemented a Graphics Processing Unit (GPU), familiar to skilled practitioners of the art.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft® Windows®, while processor ‘n’ 208 may be implemented to run a version of Linux®.

In various embodiments, one or more PEs 202 selected from a plurality of PEs 202 may be implemented within the multi-processor operating environment 200. In certain of these embodiments, a particular PE 202 selected from a plurality of PEs 202 may be vendor-specific. In various embodiments, a particular PE 202 selected from a plurality of PEs 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, a Trusted Platform Module (TPM) 260, a Platform Controller Hub (PCH) 262, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a boot loader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the TPM 260, the PCH 262, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114.

In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

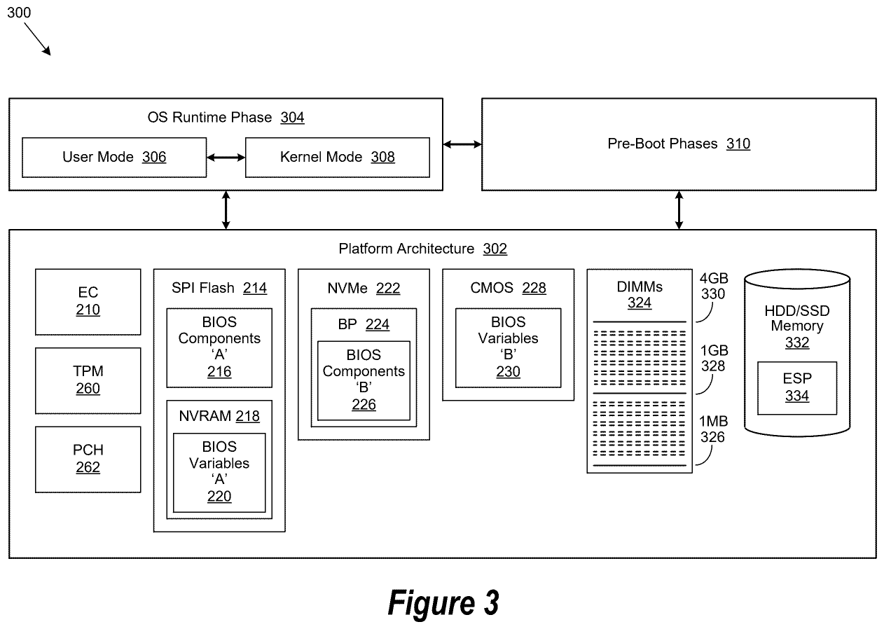

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS's may utilize different processors (e.g., Intel®, AMD®, Qualcom®, Broadcom®, NVidia®, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, a Trusted Platform Module (TPM) 260, a Platform Controller Hub (PCH) 262, Serial Peripheral Interface (SPI) Flash 214 memory, Nonvolatile Memory Express (NVMe) 222 memory, and a complementary metal-oxide-semiconductor (CMOS) 228 chip, or a combination thereof, each of which may be considered a component of an information handling system (IHS), as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the EC 210 may be implemented, directly or indirectly, within the ASDFMP 300 to provide a root of trust function. As used herein, a root of trust broadly refers to a highly reliable component, such as an EC 210, that performs specific, important security functions. In various embodiments, a root of trust component may be implemented as a building block upon which other components of the ASDFMP 300 can derive security functions.

In various embodiments, the EC 210 may be implemented to perform a root of trust operation. As used herein, a root of trust operation broadly refers to a distributed firmware management operation, described in greater detail herein, performed directly, or indirectly, within an ASFDMP 300 to provide a root of trust by leveraging a secure interface to ensure integrity and security of communication between certain components of the ASDFMP 300. In various embodiments, one or more root of trust operations may be performed to enhance the security and trustworthiness of the ASDFMP 300.

Skilled practitioners of the art will be familiar with a TPM 260, which is an international standard for a secure crypto processor, typically implemented as a dedicated microcontroller designed to secure various hardware components of an ASDFMP 300 through the use of integrated cryptographic keys. In various embodiments, a TPM 260 may be implemented to increase the security of an ASDFMP 300 and to protect it against certain firmware attacks. In various embodiments, a TPM 260 may be implemented in combination with an EC 210 to perform a root of trust operation.

Those of skill in the art will likewise be familiar with a PCH 262, which broadly refers to a family of chipsets manufactured by Intel® to control certain data paths and support functions used in conjunction with Intel® processors. However, as used herein, a PCH 262 may broadly refer to one or more processor-agnostic functionalities of an ASDFMP 300 that may be used, directly or indirectly within it, to control various data paths and support functions associated with a particular processor. Examples of such processors include those manufactured by Intel®, AMD®, Qualcomm®, Broadcom®, NVidia®, and so forth. Accordingly, various embodiments of the invention reflect an appreciation that provision of such PCH 262 functionalities may require a different implementation for each processor architecture.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1 GB 328 to 4 GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the boot loaders, or kernel images, for all installed OS's that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

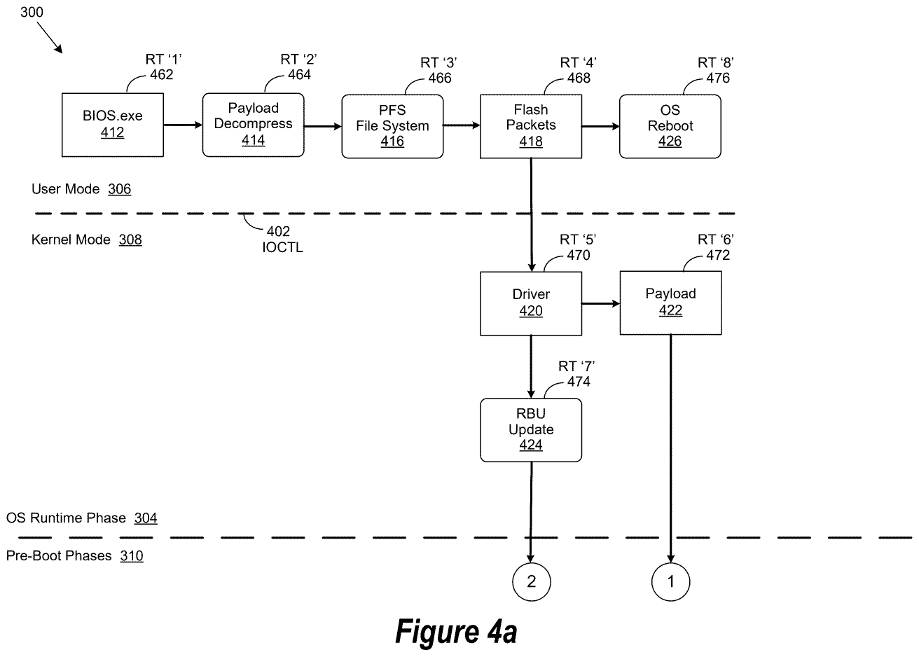

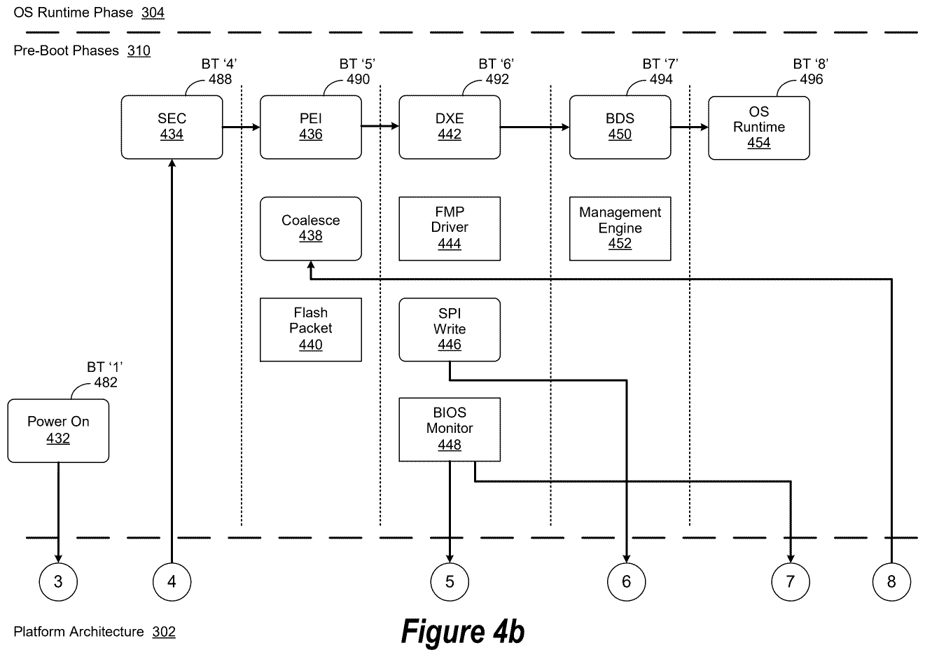

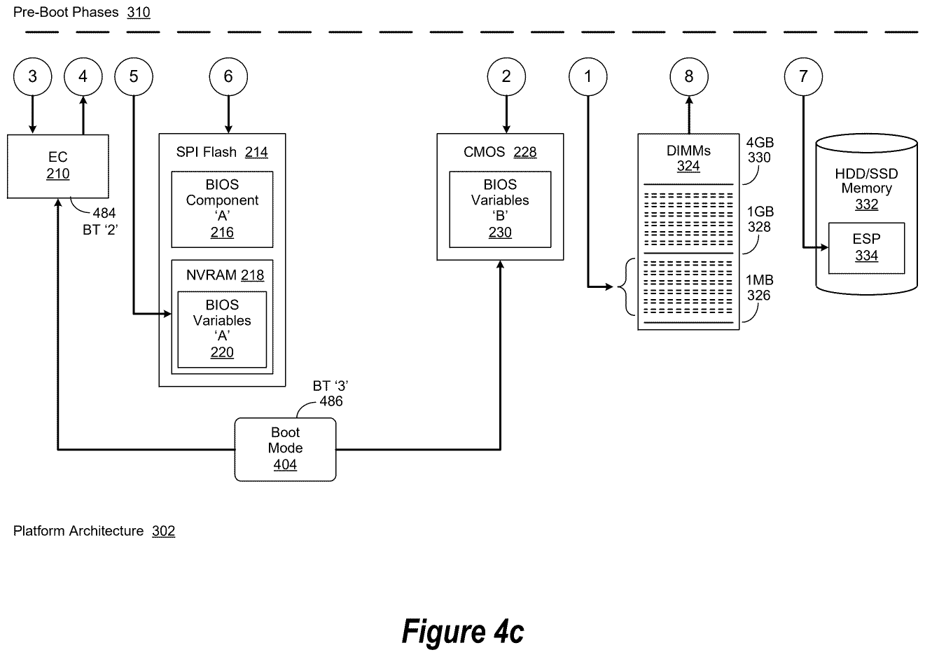

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system's (IHS's) processor in memory, switching to the new mode, and loading the new context into the processor.

Referring now to FIG. 4a, a distributed firmware management operation may be initiated by the ASDFMP 300 receiving a BIOS.exe 412 file in runtime (RT) step ‘1’ 462. In various embodiments, the BIOS.exe 412 file may be implemented as the combination of a flash memory utility and a payload of firmware components, described in greater detail herein. Then, in RT step ‘2’ 464 the BIOS.exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre Extensible Firmware Interface (EFI) Initialization (PEI) 436 phase operations in BT step ‘5’ 490. In various embodiments, the one or more SEC 434 phase operations may be implemented to secure the boot process by preventing the loading of Unified Extensible Firmware Interface (UEFI) drivers, or boot loaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 490 may include one or more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver eXecution Environment (DXE) 442 phase operation in BT step 6’ 492 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more Firmware Management Protocol (FMP) drivers 444. In general, the DXE Core component is responsible for producing a set of boot services, DXE services, and RT Services. Likewise, the DXE Dispatcher component is responsible for discovering and executing FMP drivers 444 in the correct order. In turn, the FMP drivers 444 are responsible for initializing the IHS's processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘a’ 220, or a combination of the two.

In various embodiments, a BIOS monitor 448, such as BIOS IQ, produced by Dell® Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 494, the OS is then booted. In various embodiments, a boot device selection (BDS) 450 phase operation is then performed in BT step ‘7’ 494 to select a boot device. In various embodiments, a management engine (ME) 452, such as the ME 452 produced by Intel® Corporation of Santa Clara, California, may be implemented to use the selected boot device in BT step ‘8’ 496 to boot the ASDFMP 300 into an OS runtime 454 state.

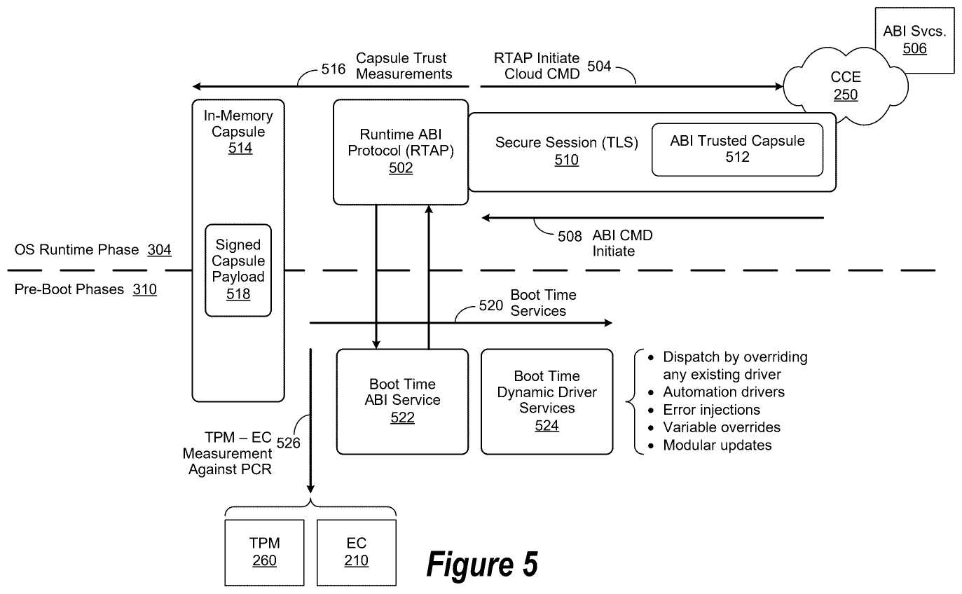

FIG. 5 is a simplified block diagram of Authenticated Basic Input/Output System (BIOS) Interface (ABI) services implemented within a cloud computing environment in accordance with an embodiment of the invention. Various embodiments of the invention reflect an appreciation that running learning models on client devices has become more common as artificial intelligence (AI) evolves. Likewise, various embodiments of the invention reflect an appreciation that large learning models (LLMs) have traditionally been deployed on powerful server infrastructures due to their extensive computational requirements.

However, various embodiments of the invention reflect an appreciation that deploying LLMs on client devices may provide certain advantages, such as a more personalized user experience, faster remediation, more immediate support, more robust data privacy, and so forth. Accordingly, an AI-capable intelligent Basic Input/Output System (BIOS), incorporating advanced algorithms and machine learning capabilities to enhance its functionality, may be implemented in various embodiments. In various embodiments, this intelligent BIOS may be implemented to autonomously detect, diagnose, and remediate issues without human intervention and provide adaptive performance and predictive maintenance.

Likewise, an eXtensible Host Controller Interface (XHCI), described in greater detail herein, may be implemented in various embodiments to improve system speed, power efficiency, and virtualization. Various embodiments of the invention likewise reflect an appreciation that typical storage capacities of portable devices have been increasing over time, with a concomitant need for high performance interfaces so they can be loaded in a reasonable amount of time. Accordingly, the implementation of an xHCI in various embodiments may reduce, or even eliminate, host memory-based transaction schedules, while its support for advanced power management features may likewise provide more power efficient platforms without sacrificing performance.

In various embodiments, the enablement of certain xHCI virtualization features may likewise allow direct assignment of individual Universal Serial Bus (USB) devices to any virtual machine (VM), irrespective of their location within a particular bus topology, to minimize run-time inter-VM communications, and provide support for native USB device sharing, or a combination thereof. Likewise, the implementation of an AI-capable intelligent BIOS in various embodiments may enable support of heterogeneous System on Chip (SoC) vendors, such as Intel®, AMD®, Qualcomm®, NVIDIA®, and so forth. The implementation of an AI-capable intelligent BIOS in various embodiments may likewise enable seamless interdependent updates services for a system's operating system (OS) and firmware. Likewise, the implementation of an intelligent cache in various embodiments may allow one or more Graphics Processing Units (GPUs), Neural Processing Units (NPUs), Accelerated Processing Units (APUs), or a combination thereof, to be leveraged to process AI workloads while supporting host embedded controller (EC) 210 side-band interrupts.

Referring now to FIG. 5, a runtime ABI protocol (RTAP) 502 may be implemented in various embodiments during a system's OS runtime phase 304. In various embodiments, the RTAP 502 may be implemented to initiate an RTAP cloud command (CMD) 504 to access certain ABI services 506, which in certain embodiments may be implemented within a cloud computing environment (CCE) 250, described in greater detail herein. In various embodiments, initiation of the RTAP cloud CMD 504 may result in certain ABI services 506 initiating an ABI CMD 508 in response.

In various embodiments, initiation of the ABI CMD 508 may result in establishing a secure session 510 between the RTAP 502 and the ABI services 506. In various embodiments, the Transport Layer Security (TLS) protocol, familiar to skilled practitioners of the art, may be used to establish the secure session 510 between the RTAP 502 and the ABI services 506. In various embodiments, the secure session 510 may be implemented to allow the ABI services 506 to provide an ABI trusted capsule 512 to the RTAP 502.

In various embodiments, the RTAP 502 may be implemented to load the ABI trusted capsule 512 into system memory as an in-memory capsule 514. In various embodiments, the RTAP 502 may likewise be implemented to perform certain capsule trust measurements 516. Likewise, the RTAP 502 may be implemented in various embodiments to generate a digitally-signed capsule payload 518.

In various embodiments, the RTAP 502 may be implemented to use the contents of the digitally-signed capsule payload 518 to create certain boot time services 520 for use during various pre-boot phases 310. In various embodiments, the boot time services 520 may include a boot time ABI service 522 and one or more boot time dynamic driver services 524. In various embodiments, the boot time ABI service 522 may be implemented to perform certain Trusted Platform Module (TPM) 260 and Embedded Controller (EC) 210 comparisons and measurements 526 against the system's Platform Configuration Register (PCR). In various embodiments the one or more boot time dynamic driver services 524 may be implemented to provide various functionalities, such as performing a dispatch by overriding any existing driver, initiating one or more automation drivers, initiating one or more error injections, performing one or more variable overrides, performing one or more modular updates, and so forth.

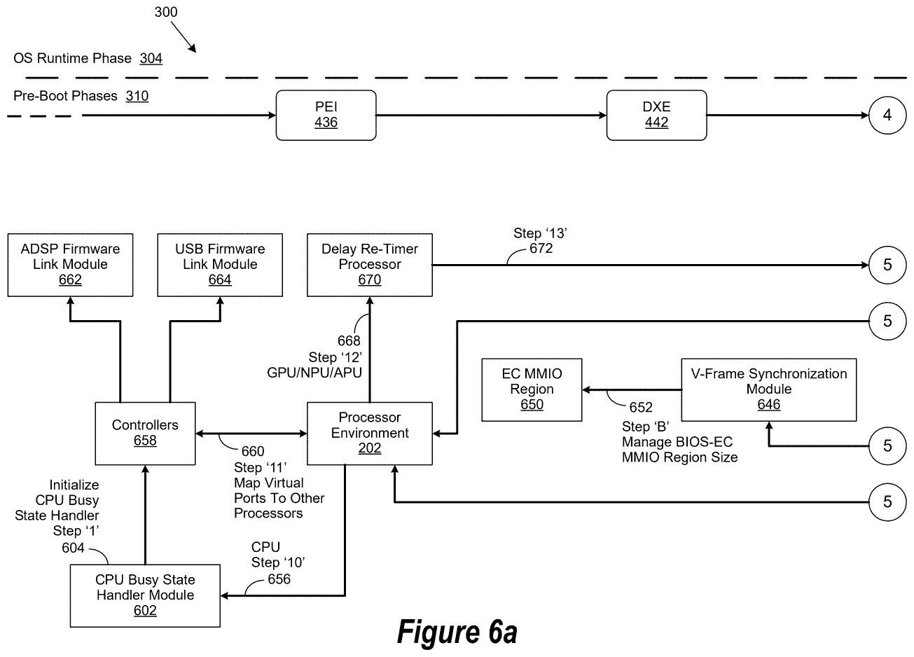

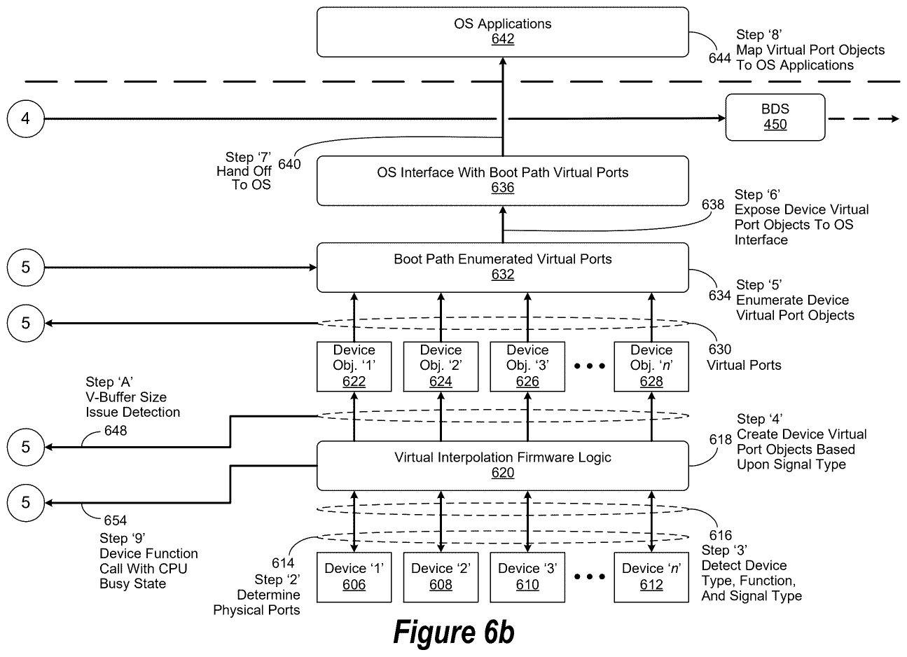

FIGS. 6a and 6b are a simplified block diagram showing the performance of certain Central Processing Unit (CPU) offload management operations implemented in accordance with an embodiment of the invention. In various embodiments, a learning-based Firmware Virtual Interpolation Protocol (FVIP) may be implemented to detect signal types in the boot path and dynamically generate an array of CPU-offloaded eXtensible Host Controller Interface (XHCI) virtual ports by intelligently decoupling CPU and third party device code to facilitate ensuring CPU-independent seamless offload operations at Operating System (OS) runtime 304. As used herein, a Firmware Virtual Interpolation Protocol broadly refers to a set of rules for formatting and processing data associated with performance of a Firmware Virtual Interpolation operation, described in greater detail herein. As used herein, a Firmware Virtual Interpolation operation broadly refers to firmware management operation, described in greater detail herein, performed directly, or indirectly, within a multi-processor operating environment 200 to detect signal types in the boot path and dynamically generate an array of CPU-offloaded virtual ports by intelligently decoupling CPU and third party device code.

In various embodiments, one or more Smart Timer Events (STE) may be implemented to manage a processor environment 202 agnostic Forward/Backward Propagation Node (FBPN). In various embodiments, the FBPN may be implemented in combination with a Graphics Processing Unit (GPU), a Neural Processing Unit (NPU), or an Accelerated Processing Unit (APU), or a combination thereof, to facilitate the availability of certain Universal Serial Bus Type C (USB-C) functionalities and device port enumeration events. In various embodiments, such USB-C availability may be facilitated by avoiding certain system conditions, such as CPU busy, crashes, hangs, and so forth. In various embodiments, one or more high performance GPU. NPU/APU accelerators may be implemented to use a Firmware Virtual Tune (FVT) learning model to identify efficient GPU offload opportunities, quantify potential performance improvements, and possible power efficiencies.

In various embodiments, one or more COM operations may be performed to detect signal types in the boot path and dynamically generate an array of CPU-offloaded eXtensible Host Controller Interface (XHCI) virtual ports 630 by intelligently decoupling CPU and third-party device party code to facilitate CPU-independent, seamless, offload operations at a system's OS runtime phase 304. In various embodiments, one or more COM operations may be performed to initialize a processor environment 202 agnostic Offload Compute Node (OCN) early in a system's Pre Extensible Firmware Interface (PEI) 436 pre-boot phase and move it to a ready state to dynamically accept any Audio Digital Signal Processor (ADSP) related COM operations during CPU busy states. In various embodiments, one or more COM operations may be performed to initialize a CPU Busy State handler with virtual ports mapping to other core processors, such as ADSP, and establish controller firmware module links early in the PEI phase. In various embodiments, one or more COM operations may be performed to use a firmware protocol to implement a Virtual Interpolation Protocol (VIP) by detecting 616 signal types in the boot path to generate an array of virtual ports 630 for ADSP-based devices, to facilitate seamless offload operations.

In various embodiments, one or more COM operations may be performed to use a Firmware Virtual Tune (FVT) learning model to identify efficient CPU offload opportunities, quantify potential performance improvements, and possible power efficiencies. In various embodiments, one or more COM operations may be performed to use a video frame (V-Frame) Synchronize module to dynamically detect frame buffer size issues and synchronize the size of BIOS Memory-Mapped Input/Output (MMIO) memory region 650 for seamless audio/video (AV) streaming issues. In various embodiments, one or more COM operations may be performed to use a Virtual Interpolation Firmware (VIFW) module to detect 648 AV device signals based upon device and function type and monitor the V-Frame buffer size. In various embodiments, one or more COM operations may be performed to use firmware logic to identify when a V-Frame buffer needs to be adjusted with Embedded Controller (EC), BIOS, or MMIO memory region size modifications at the system's runtime phase 304.

Referring now to FIGS. 6a and 6b, an architecture-specific distributed firmware management platform (ASDFMP) 300, and its associated operation, may be implemented to accommodate architecture-specific aspects of a particular information handling system (IHS), described in greater detail herein. As an example, various IHS's may utilize different processors (e.g., Intel®, AMD®, Qualcom®, Broadcom®, NVidia®, and so forth), individually or in combination with one another, and as a result, may require the use of a Basic Input/Output System (BIOS) specific to their respective architecture, or associated operating system (OS), or both, at boot time. In various embodiments, the ASDFMP 300 may be implemented to perform one or more COM operations, likewise described in greater detail herein.

In various embodiments, the ASDFMP 300 may be implemented to include an OS runtime phase 304, and various pre-boot phases 310. In various embodiments, the pre-boot phases 310 may include the performance of one or more security Pre-Extensible Firmware Interface (EFI) Initialization (PEI) 436 phase operations, one or more Driver eXecution Environment (DXE) 442 phase operations, and one or more boot device selection (BDS) 450 phase operations. In various embodiments, one or more COM operations, may be performed in step ‘1’ 604, to initialize a CPU busy state handler module 602 for use in subsequent COM operations.

In various embodiments, the ASDFMP 300 may be implemented to include one or more peripheral devices ‘1’ 606, ‘2’ 608 and ‘3’ 610 through ‘n’ 612. In various embodiments, the one or more peripheral devices ‘1’ 606, ‘2’ 608 and ‘3’ 610 through ‘n’ 612 may be implemented with a USB interface. In certain of these embodiments, the USB interface of one or more peripheral devices ‘1’ 606, ‘2’ 608 and ‘3’ 610 through ‘n’ 612 may be respectively associated with a physical port, familiar to skilled practitioners of the art.

In various embodiments, one or more COM operations may be performed in step ‘3’ 614 to determine physical ports respectively associated with the one or more peripheral devices ‘1’ 606, ‘2’ 608 and ‘3’ 610 through ‘n’ 612. In various embodiments, one or more COM operations may be performed in step ‘3’ to respectively detect the device type, function, and signal type utilized by each of the one or more peripheral devices ‘1’ 606, ‘2’ 608 and ‘3’ 610 through ‘n’ 612. In various embodiments, certain virtual interpolation firmware logic 620 may be used in the performance of one or more COM operations in step ‘4’ 618 to create device virtual port objects ‘1’ 622, ‘2’ 624 and ‘3’ 626 through ‘n’ 628 respectively corresponding to peripheral devices ‘1’ 606, ‘2’ 608 and ‘3’ 610 through ‘n’ 612.

In various embodiments, certain virtual port 630 information may be used in the performance of one or more COM operations in step ‘5’ 634 to enumerate device virtual port objects ‘1’ 622, ‘2’ 624 and ‘3’ 626 through ‘n’ 628 in the boot path of the ASDFMP 300. In various embodiments, one or more COM operations may be performed in step ‘6’ 638 to expose virtual port objects ‘1’ 622, ‘2’ 624 and ‘3’ 626 through ‘n’ 628 in the boot path of the ASDFMP 300 to its OS interface 636. In various embodiments, the ASDFMP's 300 OS interface 636 may be used in the performance of one or more COM operations in step ‘7’ 640 to hand off certain information associated with the exposed virtual port objects ‘1’ 622, ‘2’ 624 and ‘3’ 626 through ‘n’ 628 in the boot path of the ASDFMP 300 to its OS. In various embodiments, one or more COM operations may be performed in step ‘8’ 644 to map the exposed virtual port objects ‘1’ 622, ‘2’ 624 and ‘3’ 626 through ‘n’ 628 to one or more associated OS applications 642.

In various embodiments, a video frame (V-Frame) synchronization module 646 may be used in the performance of one or more COM operations in step ‘A’ 648 to detect one or more V-Buffer size issues. In various embodiments, the V-Frame synchronization module 646 may likewise be used in the performance of one or more COM operations in step ‘B’ 652 to manage the size of the ASDFMP's 300 EC MMIO region, 650, described in greater detail herein. In various embodiments, the virtual interpolation firmware logic 620 may be used in the performance of one or more COM operations in step ‘9’ 654 to provide the processor environment 202 with one or more device function calls associated with the detection a CPU busy state.

In various embodiments, one or more COM operations may be performed in step ‘10’ 656 to provide certain device function call information associated with the detection of a CPU busy state to the CPU busy state handler module 602. In various embodiments, the CPU busy state handler module 602 may be used in the performance of one or more COM operations to provide certain device function call information it may receive that is associated with the detection a CPU busy state to one or more controllers 658. In various embodiments, the one or more controllers 658 may be implemented to interact with an Audio Digital Signal (ADSP) firmware link module 662, or a USB firmware link module 664, or both.

In various embodiments, the one or more controllers 658 may be used in the performance of one or more COM operations in step ‘11’ 660 to virtual ports 630 to other processors in the processor environment 202. In various embodiments, use the processor environment 202 in the performance of one or more COM operations in step ‘12’ 668 to provide certain associated GPU/NPU/APU utilization and availability information to a delay re-time processor 670. In various embodiments, the delay re-timer processor 670 may be used in the performance of one or more COM operations to determine which boot path enumerated virtual ports 632 are available for association with a particular GPU, NPU, or APU implemented within the processor environment 202. Those of skill in the art will recognize that many such embodiments are possible. Accordingly, the foregoing is not intended to limit the spirit, scope, or intent of the invention.

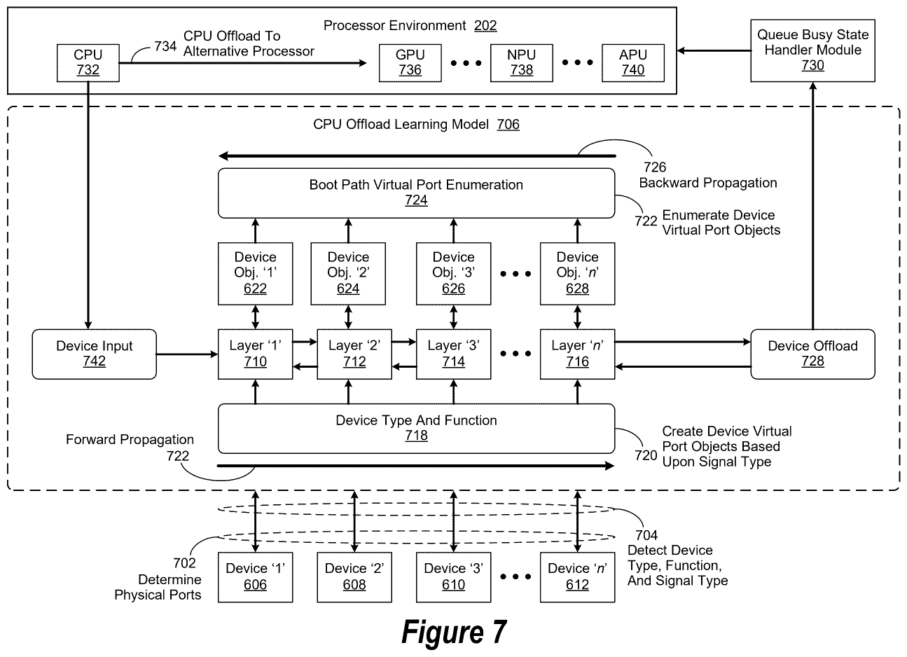

FIG. 7 is a simplified block diagram of the operation of a firmware virtual interpolation protocol implemented in accordance with an embodiment of the invention. In various embodiments, an architecture-specific distributed firmware management platform (ASDFMP), described in greater detail herein, may be implemented to include a processor environment, likewise described in greater detail herein. In various embodiments, the processor environment 202 may be implemented to include one or Central Processing Units (CPUs) 732, one or more Graphics Processing Units (GPUs) 736, one or more Neural Processing Units (NPUs) 738, one or more Accelerated Processing Units (APUs) 740, or a combination thereof.

In various embodiments, the ASDFMP may be implemented to include one or more peripheral devices ‘1’ 606, ‘2’ 608 and ‘3’ 610 through ‘n’ 612, as described in greater detail herein. In various embodiments, one or more CPU offload management (COM) operations, likewise described in greater detail herein, may be performed to determine 702 physical ports respectively associated with the one or more peripheral devices ‘1’ 606, ‘2’ 608 and ‘3’ 610 through ‘n’ 612. In various embodiments, one or more COM operations may likewise be performed to respectively detect the device type, function, and signal type utilized by each of the one or more peripheral devices ‘1’ 606, ‘2’ 608 and ‘3’ 610 through ‘n’ 612.

In various embodiments, one or more COM operations may be performed to provide certain information associated with the device type, function, and signal type utilized by each of the one or more peripheral devices ‘1’ 606, ‘2’ 608 and ‘3’ 610 through ‘n’ 612 to a CPU offload learning model 706. In various embodiments, the CPU offload learning model 706 may be implemented to include a device type and function 718 module, a boot path virtual port enumeration 724 module, a device offload 728 module, and a device input 742 module. In various embodiments, the device type and function 718 module may be used in the performance of one or more COM operations to receive certain information associated with the device type, function, and signal type utilized by each of the one or more peripheral devices ‘1’ 606, ‘2’ 608 and ‘3’ 610 through ‘n’ 612.

In various embodiments, the device type and function 718 module may be used in the performance of one or more COM operations to create 720 device virtual port objects ‘1’ 622, ‘2’ 624 and ‘3’ 626 through ‘n’ 628 respectively corresponding to the one or more peripheral devices ‘1’ 606, ‘2’ 608 and ‘3’ 610 through ‘n’ 612. In various embodiments, the device type and function 718 module may likewise be used in the performance of one or more COM operations to create interface layers ‘1’ 710, ‘2’ 712, and ‘3’ 714 through ‘n’ 716 respectively corresponding to device virtual port objects ‘1’ 622, ‘2’ 624 and ‘3’ 626 through ‘n’ 628. In various embodiments, the interface layers ‘1’ 710, ‘2’ 712, and ‘3’ 714 through ‘n’ 716 may be used in the performance of one or more COM operations to provide and retrieve certain information respectively corresponding to device virtual port objects ‘1’ 622, ‘2’ 624 and ‘3’ 626 through ‘n’ 628. In various embodiments, the boot path virtual port enumeration 724 module may be used in the performance of one or more COM operations to enumerate virtual port objects ‘1’ 622, ‘2’ 624 and ‘3’ 626 through ‘n’ 628.

In various embodiments, the interface layers ‘1’ 710, ‘2’ 712, and ‘3’ 714 through ‘n’ 716 may be used in the performance of one or more COM operations to provide certain information respectively corresponding to device virtual port objects ‘1’ 622, ‘2’ 624 and ‘3’ 626 through ‘n’ 628 to the device offload 728 module. In various embodiments, the device offload 728 module may be used in the performance of one or more COM operations to provide certain information associated with device virtual port objects ‘1’ 622, ‘2’ 624 and ‘3’ 626 through ‘n’ 628 tp a queue busy state handler 730 module. In various embodiments, the busy state handler 730 module may be used in the performance of one or more COM operations to use the device virtual port object information it may receive to offload 734 certain operations from a particular CPU 732 to an alternative processor, such as a particular GPU 736, or a particular NPU 738, or a particular APU 740.

In various embodiments, the CPU 732 may be used in one or more COM operations to provide certain CPU offload information to the device input 742 module. In turn, the device input 742 module may be used in the performance of one or more COM operations to provide certain CPU offload information it may receive from the CPU 732 to interface layers ‘1’ 710, ‘2’ 712, and ‘3’ 714 through ‘n’ 716. Accordingly, the CPU offload learning model 708 may be implemented in various embodiments to learn the offloading of certain operations from a CPU 732 to an alternative processor, such as a particular GPU 736, or a particular NPU 738, or a particular APU 740, through both forward 722 and backward 726 propagation of operations between the device input 742 module and the device output 728 module.

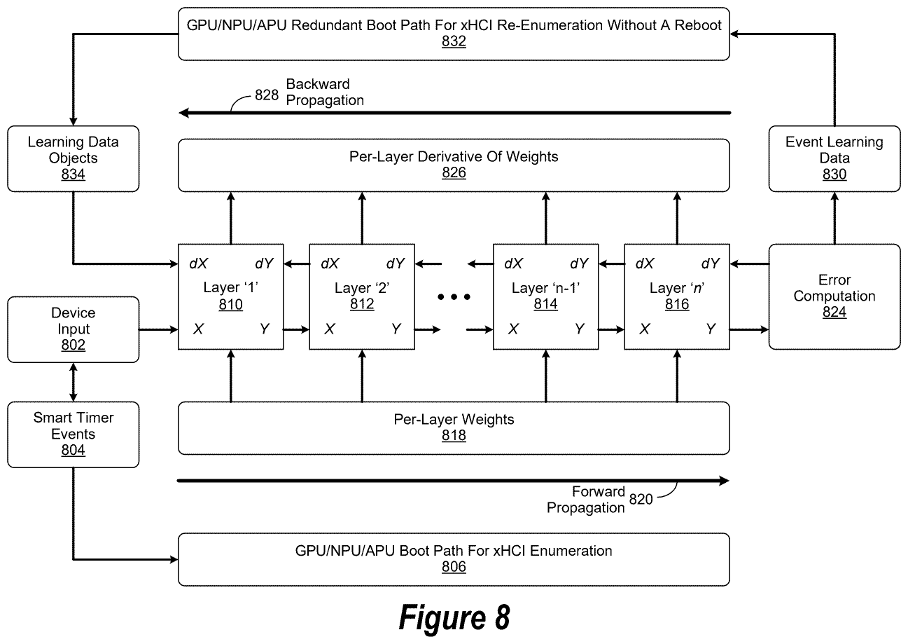

FIG. 8 is a simplified block diagram of a Central Processing Unit (CPU) offload learning model implemented in accordance with an embodiment of the invention. In various embodiments, one or more CPU Offload Management (COM) operations, described in greater detail herein, may be performed to use one or more Smart Timer Events (STEs) 804 in combination with a Graphics Processing Unit (GPU), a Neural Processing Unit (NPU), or an Accelerated Processing Unit (APU), or a combination thereof, to facilitate the availability of certain Universal Serial Bus Type C (USB-C) functionalities and device port enumeration events. In various embodiments, such USB-C availability may be facilitated by avoiding certain system conditions, such as CPU busy, crashes, hangs, and so forth.

In various embodiments, one or more COM operations may be performed to detect a device signal at runtime, as described in greater detail herein. In certain of these embodiments, one or more COM operations may likewise be performed to use interpolation logic to detect the signal type based upon device function and type, and then create a virtual port mapping. In various embodiments, one or more COM operations may be performed to use a boot path virtual port enumeration module to create device objects based upon their signal type.

Referring now to FIG. 8, one or more COM operations may be performed in various embodiments to use certain peripheral device input information 802 in combination with certain smart timer event 804 information to generate a GPU/NPU/APU boot path for eXtensible Host Controller Interface (XHCI) enumeration 806. In various embodiments, one or more COM operations may be performed to apply per-layer weights 818 to generate a weighted output value ‘Y’ from a device input 802 value ‘X’ respectively corresponding to port object interface layers ‘1’ 810, ‘2’ 812, through ‘n−1’ 814 and ‘n’ 816, described in greater detail herein. In various embodiments, a forward propagation value associated with forward propagation 820 may be calculated by the application of per-layer weights 818 to generate a weighted output value ‘Y’ from a device input 802 value ‘X’ respectively corresponding to port object interface layers ‘1’ 810, ‘2’ 812, through ‘n−1’ 814 and ‘n’ 816.

In various embodiments, an error computation 824 module may be used in the performance of one or more COM operations to compute possible errors resulting from the application of individual per-layer weights 818 to generate a weighted output value ‘Y’ from a device input 802 value ‘X’. In various embodiments, certain information associated with errors computed by the error computation 824 module may be used in the performance of one or more COM operations to produce a derivative input value dX and derivative output value dY respectively corresponding to input value X and output value Y. In various embodiments, the error computation 824 module may be used in the performance of one or more COM operations to generate certain event learning data 830 from the input value X, its associated derivative input value dX, the weighted output value Y, and its associated derivative output value dY respectively corresponding to port object interface layers ‘1’ 810, ‘2’ 812, through ‘n−1’ 814 and ‘n’ 816. In various embodiments, a backward propagation value associated with backward propagation 828 may be calculated by the application of per-layer derivative of weights 826 to generate a weighted derivative input value ‘dX’ from a weighted derivative output value ‘dY’ respectively corresponding to port object interface layers ‘1’ 810, ‘2’ 812, through ‘n−1’ 814 and ‘n’ 816.

In various embodiments, the event learning data 830 may be used in the performance of one or more COM operations to generate a GPU/NPU/APU redundant boot path for XHCI enumeration 832. In various embodiments, the GPU/NPU/APU redundant boot path for XHCI enumeration 832 may be used in the performance of one or more COM operations to generate one or more learning data objects 834. In various embodiments, the one or more learning data objects 834 may be used in the performance of one or more COM operations as input data to port object interface layers ‘1’ 810, ‘2’ 812, through ‘n−1’ 814 and ‘n’ 816. Skilled practitioners of the art will recognize that many such embodiments are possible. Accordingly, the foregoing is not intended to limit the spirit, scope, or intent of the invention.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a firmware management operation, comprising:
providing an information handling system with a distributed unified BIOS;
identifying a processor environment installed on an information handling system from a plurality of processor environments, the processor environment comprising a processor architecture, the information handling system including a graphics processing unit (GPU); and,
performing a GPU offload management operation, the GPU offload management operation managing an aspect of offloading a processing operation to the GPU.

2. The method of claim 1, wherein:
the GPU offload management operation includes performing a firmware virtual interpolation operation, the firmware virtual interpolation operation detecting signal types in a boot path and dynamically generating an array of CPU-offloaded virtual ports.

3. The method of claim 1, wherein:
the GPU offload management operation uses a CPU offload model, the CPU offload model learning offloading of operations from a CPU to the GPU.

4. The method of claim 3, wherein:
the CPU offload model learns from forward propagation and backward propagation of operations between a device input module and a device output module.

5. The method of claim 4, wherein:
a forward propagation value is calculated by application of per-layer weights to generate a weighted output value ‘Y’ from a device input value ‘X’ corresponding to port object interface layer.

6. The method of claim 4, wherein:
a backward propagation value is calculated by the application of per-layer derivative of weights to generate a weighted derivative input value ‘dX’ from a weighted derivative output value ‘dY’ corresponding to a port object interface layer.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed unified BIOS;
identifying a processor environment installed on an information handling system from a plurality of processor environments, the processor environment comprising a processor architecture, the information handling system including a graphics processing unit (GPU); and,
performing a GPU offload management operation, the GPU offload management operation managing an aspect of offloading a processing operation to the GPU.

8. The system of claim 7, wherein:
the GPU offload management operation includes performing a firmware virtual interpolation operation, the firmware virtual interpolation operation detecting signal types in a boot path and dynamically generating an array of CPU-offloaded virtual ports.

9. The system of claim 7, wherein:
the GPU offload management operation uses a CPU offload model, the CPU offload model learning offloading of operations from a CPU to the GPU.

10. The system of claim 9, wherein:
the CPU offload model learns from forward propagation and backward propagation of operations between a device input module and a device output module.

11. The system of claim 10, wherein:
a forward propagation value is calculated by application of per-layer weights to generate a weighted output value ‘Y’ from a device input value ‘X’ corresponding to port object interface layer.

12. The system of claim 10, wherein:
a backward propagation value is calculated by the application of per-layer derivative of weights to generate a weighted derivative input value ‘dX’ from a weighted derivative output value ‘dY’ corresponding to a port object interface layer.

13. A non-transitory, computer-readable storage medium embodying computer program code, the computer program code comprising computer executable instructions configured for:
providing an information handling system with a distributed unified BIOS;
identifying a processor environment installed on an information handling system from a plurality of processor environments, the processor environment comprising a processor architecture, the information handling system including a graphics processing unit (GPU); and,
performing a GPU offload management operation, the GPU offload management operation managing an aspect of offloading a processing operation to the GPU.

14. The non-transitory, computer-readable storage medium of claim 13, wherein:
the GPU offload management operation includes performing a firmware virtual interpolation operation, the firmware virtual interpolation operation detecting signal types in a boot path and dynamically generating an array of CPU-offloaded virtual ports.

15. The non-transitory, computer-readable storage medium of claim 13, wherein:
the GPU offload management operation uses a CPU offload model, the CPU offload model learning offloading of operations from a CPU to the GPU.

16. The non-transitory, computer-readable storage medium of claim 15, wherein:
the CPU offload model learns from forward propagation and backward propagation of operations between a device input module and a device output module.

17. The non-transitory, computer-readable storage medium of claim 16, wherein:
a forward propagation value is calculated by application of per-layer weights to generate a weighted output value ‘Y’ from a device input value ‘X’ corresponding to port object interface layer.

18. The non-transitory, computer-readable storage medium of claim 16, wherein:
a backward propagation value is calculated by the application of per-layer derivative of weights to generate a weighted derivative input value ‘dX’ from a weighted derivative output value ‘dY’ corresponding to a port object interface layer.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
